(19) United States
(12) Patent Application Publication
(10) Pub. No.: US 2026/0285071 A1
(43) Pub. Date: Sep. 24, 2026

(54) LIQUID DROPLET DISCHARGE HEAD AND RECORDING DEVICE

(71) Applicant: KYOCERA Corporation, Kyoto (JP)

(72) Inventors: Naoto MIYAKOSHI, Osaka-shi, Osaka (JP); Masaru IWABUCHI, Kirishima-shi, Kagoshima (JP)

(21) Appl. No.: 19/477,786

(22) PCT Filed: Apr. 24, 2024
(86) PCT No.: PCT/JP2024/016086

§ 371 Date: Oct. 23, 2025

(30) Foreign Application Priority Data
Apr. 27, 2023 (JP) 2023-073102

(51) Int. Cl. B41J 29/13; B41J 2/175; B41J 29/377

(52) U.S. Cl. CPC B41J 29/13; B41J 2/175; B41J 29/377

(57) ABSTRACT

A liquid droplet discharge head according to the present disclosure includes a channel member, a reservoir, a tube, and an auxiliary member. The channel member includes a plurality of discharge holes through which a liquid droplet is discharged. The reservoir is positioned above the channel member, supplies a liquid to the channel member, and includes a boss portion made of resin into which the tube is fitted. The tube supplies a liquid into the reservoir. The auxiliary member includes a first through hole surrounding the tube fitted into the boss portion with a gap.

### CROSS-REFERENCE TO RELATED APPLICATIONS

This application is national stage application of International Application No. PCT/JP2024/016086, filed on Apr. 24, 2024 which designates the United States, and which claims the benefit of priority from Japanese Patent Application No. 2023-073102, filed on Apr. 27, 2023.

### TECHNICAL FIELD

The present disclosure relates to a liquid droplet discharge head and a recording device.

### BACKGROUND OF INVENTION

Conventionally, as a printing head, for example, a liquid droplet discharge head is known that performs various types of printing by discharging a liquid supplied from an ink tank via a tube onto a recording medium. Patent Document 1 discloses an inkjet head that includes a joint member screwed to a head body and a tube fitted into a metal pipe provided in the joint member.

### CITATION LIST

### Patent Literature

Patent Document 1: JP 2005-106092 A

### SUMMARY

A liquid droplet discharge head according to an aspect of the present disclosure includes a channel member, a reservoir, a tube, and an auxiliary member. The channel member includes a plurality of discharge holes through which a liquid droplet is discharged. The reservoir is positioned above the channel member, supplies a liquid to the channel member, and includes a boss portion made of resin into which the tube is fitted. The tube supplies a liquid into the reservoir. The auxiliary member includes a first through hole surrounding the tube fitted into the boss portion with a gap.

### BRIEF DESCRIPTION OF THE DRAWINGS

FIG. 1 is a schematic side view of a printer according to a first embodiment.

FIG. 2 is a schematic plan view of the printer according to the first embodiment.

FIG. 3 is an exploded perspective view illustrating an overall configuration of a liquid droplet discharge head according to the first embodiment.

FIG. 4 is an exploded perspective view illustrating a configuration of an auxiliary member and a peripheral member thereof according to the first embodiment.

FIG. 5 is a perspective view illustrating the configuration of the auxiliary member and the peripheral member thereof according to the first embodiment.

FIG. 6 is a cross-sectional view taken along line VI-VI illustrated in FIG. 5.

FIG. 7 is a diagram illustrating the configuration of the auxiliary member according to the first embodiment.

FIG. 8 is an enlarged view illustrating a configuration of a head cover according to the first embodiment.

FIG. 9 is a perspective view illustrating a configuration of an auxiliary member according to a second embodiment.

### DESCRIPTION OF EMBODIMENTS

In the following, embodiments for implementing a liquid droplet discharge head and a recording device according to the present disclosure (hereinafter referred to as “embodiments”) will be described in detail with reference to the drawings. Note that the present disclosure is not limited by the embodiments. Embodiments can be appropriately combined within a range so as not to contradict each other in terms of processing content. In the following embodiments, the same portions are denoted by the same reference signs, and redundant descriptions are omitted.

In the following embodiments, expressions such as “certain”, “orthogonal”, “perpendicular”, and “parallel” may be used, but these expressions need not mean exactly “certain”, “orthogonal”, “perpendicular”, and “parallel”. In other words, each of the expressions described above allows for deviations in, for example, manufacturing accuracy, or installation accuracy.

In the drawings referenced below, to facilitate understanding, an orthogonal coordinate system may be defined, in which the X-axis direction, Y-axis direction, and Z-axis direction mutually orthogonal are specified, and the positive Z-axis direction is set as the vertically upward direction.

Conventionally, a reservoir of a liquid droplet discharge head is formed of metal. A pipe made of metal is mounted to the reservoir made of metal by screws or the like, and a tube is fitted into the pipe.

In recent years, it has been considered to form the reservoir with resin. When the reservoir is formed of resin, it is easy to mold a boss portion, which replaces the configuration of the conventional pipe, integrally with the reservoir. However, the boss portion made of resin has a lower strength against bending than the boss portion made of metal, and thus is likely to be broken when a force is applied in a direction in which the boss portion is bent. The breakage of the boss portion is likely to occur particularly when fitting the tube into the boss portion. The boss portion may also be broken while the liquid droplet discharge head is used.

Therefore, a technique for reducing the breakage of the boss portion is expected.

### First Embodiment

### Configuration of Printer

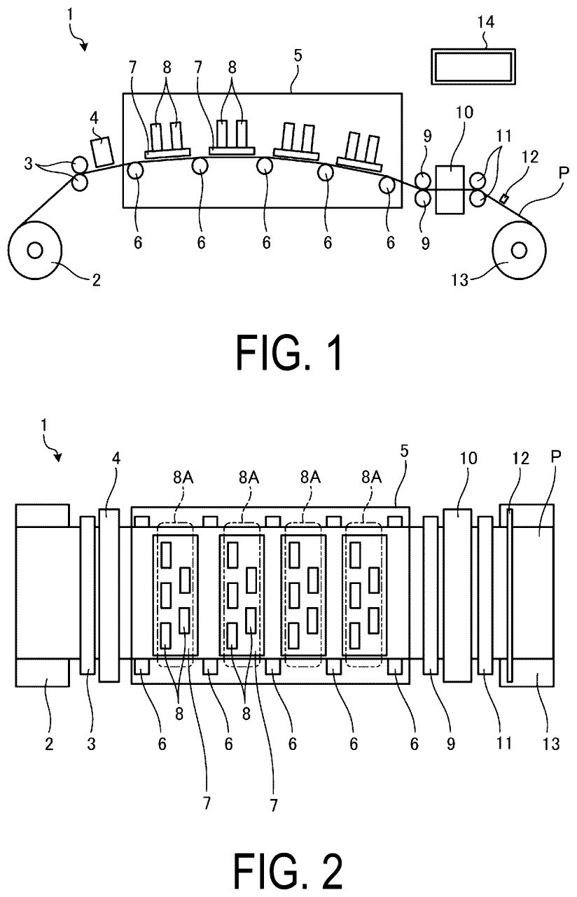

First, an outline of a printer 1, which is an example of a recording device according to a first embodiment, will be described with reference to FIGS. 1 and 2. FIG. 1 is a schematic side view of the printer 1 according to the first embodiment, and FIG. 2 is a schematic plan view of the printer 1 according to the first embodiment. The printer 1 according to the first embodiment is, for example, a color inkjet printer.

As illustrated in FIG. 1, the printer 1 includes a paper feed roller 2, guide rollers 3, an applicator 4, a head case 5, a plurality of transport rollers 6, a plurality of frames 7, a plurality of liquid droplet discharge heads 8, transport rollers 9, a dryer 10, transport rollers 11, a sensor unit 12, and a collection roller 13.

The printer 1 further includes a controller 14 that controls the paper feed roller 2, the guide rollers 3, the applicator 4, the head case 5, the plurality of transport rollers 6, the plurality of frames 7, the plurality of liquid droplet discharge heads 8, the transport rollers 9, the dryer 10, the transport rollers 11, the sensor unit 12, and the collection roller 13.

The printer 1 records images or characters on printing paper P by causing liquid droplets to land on the printing paper P. The printing paper P is an example of a recording medium. The printing paper P is wound around the paper feed roller 2 before use. The printer 1 transports the printing paper P from the paper feed roller 2 to the inside of the head case 5 via the guide rollers 3 and the applicator 4.

The applicator 4 uniformly applies a coating agent onto the printing paper P. This ensures that surface treatment can be performed on the printing paper P, thereby improving the printing quality of the printer 1.

The head case 5 accommodates the plurality of transport rollers 6, the plurality of frames 7, and the plurality of liquid droplet discharge heads 8. The inside of the head case 5 forms a space isolated from the outside except for a portion connected to the outside, such as a portion where the printing paper P enters and leaves.

In the internal space of the head case 5, at least one of control factors such as temperature, humidity, and air pressure is controlled by the controller 14 as required. The transport rollers 6 transport the printing paper P to the vicinity of the liquid droplet discharge heads 8 inside the head case 5.

The frames 7 are rectangular flat plates and positioned above and in close proximity to the printing paper P that is transported by the transport rollers 6. As illustrated in FIG. 2, the frame 7 is positioned such that a longitudinal direction thereof is orthogonal to a transport direction of the printing paper P. The plurality (for example, four) of frames 7 are positioned inside the head case 5 along the transport direction of the printing paper P.

Note that, in the following description, a direction in which the printing paper P is transported is also referred to as a “sub-scanning direction,” and a direction orthogonal to the sub-scanning direction and parallel to the printing paper P is also referred to as a “main scanning direction”.

A liquid, for example, ink, is supplied from a liquid tank (not illustrated) to the liquid droplet discharge head 8. The liquid droplet discharge head 8 discharges liquid droplets supplied from the liquid tank.

The controller 14 controls the liquid droplet discharge heads 8 based on data such as images and characters to discharge the liquid droplets toward the printing paper P. A distance between the liquid droplet discharge head 8 and the printing paper P is, for example, about 0.5 to 20 mm.

The liquid droplet discharge head 8 is fixed to the frame 7. For example, both end portions of the liquid droplet discharge head 8 in the longitudinal direction thereof are fixed to the frame 7. The liquid droplet discharge head 8 is positioned such that the longitudinal direction thereof is orthogonal to the transport direction of the printing paper P.

That is, the printer 1 according to the first embodiment is a so-called line printer in which the liquid droplet discharge heads 8 are fixed inside the printer 1. Note that the printer 1 according to the first embodiment is not limited to the line printer, but may be a so-called serial printer. A serial printer is a printer that alternately performs the transport of the printing sheet P, and the recording operation that is performed while moving the liquid droplet discharge head 8 in a direction that intersects the transport direction of the printing sheet P, such as a direction substantially orthogonal to the transport direction of the printing sheet P.

As illustrated in FIG. 2, a plurality of (for example, five) liquid droplet discharge heads 8 are fixed to one frame 7. FIG. 2 illustrates an example in which three of the liquid droplet discharge heads 8 are positioned on the front side and two of the liquid droplet discharge heads 8 are positioned on the rear side in the transport direction of the printing paper P. The liquid droplet discharge heads 8 are positioned such that the centers thereof do not overlap each other in the transport direction of the printing paper P.

The plurality of liquid droplet discharge heads 8 positioned on one frame 7 constitute a head group 8A. Four head groups 8A are positioned along the transport direction of the printing paper P. The same color ink is supplied to the liquid droplet discharge heads 8 belonging to the same head group 8A. Thus, the printer 1 can perform printing with inks of four colors using the four head groups 8A.

The colors of the inks discharged from the respective head groups 8A are, for example, magenta (M), yellow (Y), cyan (C), and black (K). The controller 14 can print a color image on the printing paper P by controlling each of the head groups 8A and discharging inks of a plurality of colors onto the printing paper P.

Note that, in order to treat the surface of the printing paper P, the liquid droplet discharge heads 8 may discharge the coating agent onto the printing paper P.

The number of the liquid droplet discharge heads 8 included in one head group 8A or the number of the head groups 8A mounted on the printer 1 can be changed as appropriate in accordance with a printing target or printing conditions. For example, when the color to be printed on the printing paper P is a single color and a printing range can be covered by one liquid droplet discharge head 8, the number of liquid droplet discharge heads 8 mounted on the printer 1 may be one.

The printing paper P that has been printed inside the head case 5 is transported to the outside of the head case 5 by the transport rollers 9, and passes through the inside of the dryer 10. The dryer 10 dries the printing paper P that has been printed. The printing paper P dried by the dryer 10 is transported by the transport rollers 11 and collected by the collection roller 13.

In the printer 1, drying the printing sheet P with the drier 10 can reduce adhesion of the printing sheets P wound in an overlapping manner, and rubbing of undried liquid on the collection roller 13.

The sensor unit 12 is constituted by, for example, a position sensor, a speed sensor, a temperature sensor, or the like. Based on information from the sensor unit 12, the controller 14 can determine a state of each unit of the printer 1 and control each unit of the printer 1.

The printer 1 described above uses the printing paper P as a printing target (i.e., a recording medium), but the printing target in the printer 1 is not limited to the printing paper P. For example, the printing target may be a rolled cloth.

Instead of directly transporting the printing paper P, the printer 1 may transport the printing paper P placed on a transport belt. By using the transport belt, the printer 1 can use a sheet of paper, a cut cloth, wood, a tile, or the like as the printing target.

The printer 1 may print wiring patterns of an electronic device by discharging liquid droplets containing conductive particles from the liquid droplet discharge heads 8. The printer 1 may also discharge a predetermined amount of a liquid chemical agent or liquid droplets containing the chemical agent from the liquid droplet discharge heads 8 onto a reaction vessel or the like to produce chemicals.

In addition, the printer 1 may also include a cleaning unit that cleans the liquid droplet discharge heads 8. The cleaning unit cleans the liquid droplet discharge heads 8 by performing, for example, a wiping process or a capping process.

The wiping process is a process for removing a liquid adhering to the liquid droplet discharge head 8 by wiping a surface of a portion onto which the liquid droplets are discharged, for example, using a flexible wiper.

The capping process is performed, for example, as follows. First, a cap is placed over the surface of the portion onto which the liquid droplets are discharged (this is called capping). This creates a substantially hermetically sealed space between the cap and the surface of the portion onto which the liquid droplets are discharged.

Subsequently, the discharge of the liquid droplets is repeated in the sealed space. As a result, liquid having a viscosity higher than that of the liquid in a normal state, foreign matter, or the like stuck in discharge holes (nozzles) for discharging the liquid droplets can be removed.

### Configuration of Liquid Droplet Discharge Head

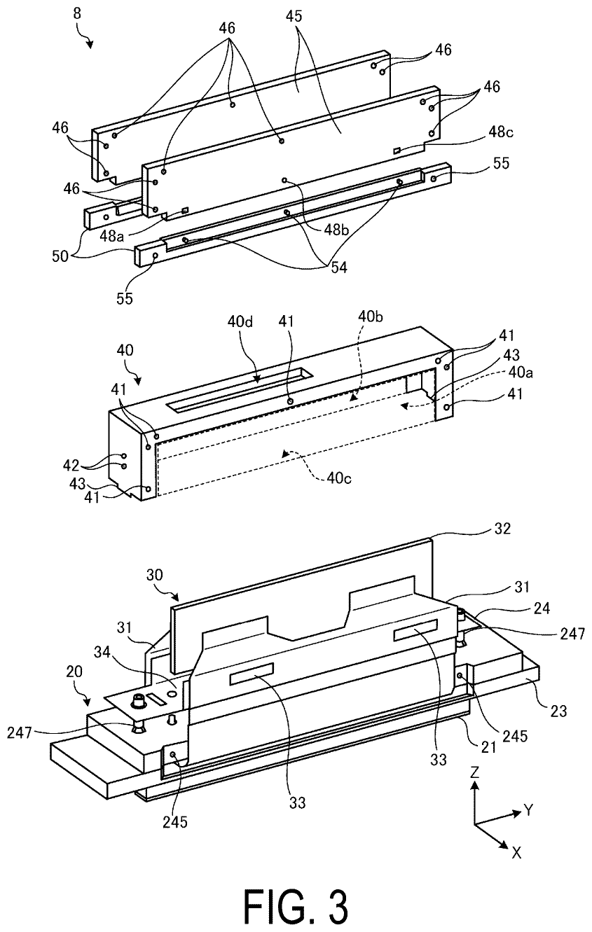

Subsequently, a configuration of the liquid droplet discharge head 8 according to the first embodiment will be described with reference to FIG. 3. FIG. 3 is an exploded perspective view illustrating an overall configuration of the liquid droplet discharge head 8 according to the first embodiment. Note that, in FIG. 3, a tube 60 and an auxiliary member 70 are omitted for ease of understanding.

The liquid droplet discharge head 8 includes a head body 20, a tube 60 (see FIG. 6), a wiring portion 30, a head cover 40, two heat dissipation plates 45, and two thermal insulating members 50. The head body 20 includes a channel member 21, a piezoelectric actuator substrate (not illustrated), a branched channel member 23, and a reservoir 24.

In the following description, for convenience, a direction in which the head body 20 is provided in the liquid droplet discharge head 8 may be referred to as “lower”, and a direction in which the head cover 40 is provided with respect to the head body 20 may be referred to as “upper”.

The channel member 21 of the head body 20 has a substantially flat plate shape and has a first surface 21a (not illustrated), which is one main surface, and a second surface 21b (not illustrated) positioned on an opposite side to the first surface. The first surface 21a includes an opening (not illustrated), and liquid is supplied from the reservoir 24 to the inside of the channel member 21 through the opening.

A plurality of discharge holes (not illustrated) through which the liquid is discharged onto the printing paper P are positioned in the second surface. The channel member 21 internally includes a channel through which the liquid flows from the first surface to the second surface.

The piezoelectric actuator substrate is positioned on the first surface of the channel member 21. The piezoelectric actuator substrate includes a plurality of displacement elements (not illustrated). The piezoelectric actuator substrate is electrically connected to a flexible substrate 31 of the wiring portion 30.

The branched channel member 23 is positioned on the channel member 21. The branched channel member 23 internally includes a branched channel (not illustrated) connected to the channel of the channel member 21. The branched channel member 23 is composed of metal, for example. The branched channel member 23 is a member having a box shape extending long in the main scanning direction (Y-axis direction), with an upper surface opened. The branched channel member 23 has a slit portion (not illustrated), and the flexible substrate 31 connected to the piezoelectric actuator substrate is inserted into the slit portion.

The reservoir 24 is positioned on the branched channel member 23. The reservoir 24 is an injection molded product made of resin. The reservoir 24 is provided with boss portions 247 at both end portions in the main scanning direction (Y-axis direction). Here, the description “made of resin” means that an article is fabricated from resin, and includes those in which resin is a main component and a small amount of impurities is contained. The boss portions 247 are molded integrally with the reservoir 24. The tube 60 described below is fitted into the boss portion 247. Specifically, the tube 60 is fixed in contact with an outer peripheral surface of the boss portion 247. The reservoir 24 internally includes a channel, and liquid is supplied from the outside via the tube 60. The reservoir 24 supplies the liquid to the branched channel member 23. The reservoir 24 stores the liquid that is supplied to the branched channel member 23. The reservoir 24 will be described in detail below.

The tube 60 (see FIG. 6) is a flexible piping member for supplying and recovering liquid to and from the inside of the reservoir 24. The tubes 60 are fitted into the boss portions 247 positioned at both end portions of the reservoir 24 in the main scanning direction (Y-axis direction). The liquid is supplied to the reservoir 24 via the tube 60 connected to one of the two boss portions 247. The liquid supplied to the reservoir 24 is discharged from the reservoir 24 via the tube 60 connected to the other of the two boss portions 247.

Note that, upon printing, the liquid may be supplied from one tube 60 and the other tube 60 may be closed. The liquid may be supplied from both the tubes 60. When first introducing the liquid into the liquid droplet discharge head 8, if the liquid is supplied from one tube 60 and recovered from the other tube 60, air, a preservative solution, or the like in the channel inside the reservoir 24 easily escapes from the channel, and thus the introduction of the liquid into the liquid droplet discharge head 8 can be facilitated.

During the printing, the liquid may be supplied from one tube 60 and may be recovered from the other tube 60. In this manner, bubbles are less retained in the channel inside the reservoir 24. Supplying a liquid adjusted to a constant temperature allows the temperature of the liquid droplet discharge head 8 to be stabilized. The recovered liquid may be passed through a filter or the like before being supplied to the liquid droplet discharge head 8 once again. In other words, the liquid may be circulated. The controller 14 may control the supply and recovery of the liquid to and from the liquid droplet discharge head 8, or may control the circulation of the liquid.

Liquid may be supplied from the reservoir 24 to the channel member 21, and liquid may be recovered from the channel member 21 to the reservoir 24. In the channel member 21, the liquid may be supplied to and recovered from the channel facing the nozzles (discharge holes) so that the liquid is less likely to stay in the nozzles and the periphery thereof. In such a mode, as a whole, the liquid is supplied to the liquid droplet discharge heads 8 from the outside, a part of the liquid is discharged from the discharge holes, and the liquid that has not been discharged is recovered to the outside.

The wiring portion 30 includes the flexible substrate 31, a wiring board 32, a plurality of driver ICs 33, and a pressing member 34. The flexible substrate 31 is a flexible wiring board, and transmits to the head body 20 a predetermined signal sent from the outside. Note that, as illustrated in FIG. 3, the liquid droplet discharge head 8 according to the first embodiment includes two flexible substrates 31.

The flexible substrate 31 includes one end portion electrically connected to the piezoelectric actuator substrate of the head body 20. The other end portion of the flexible substrate 31 is drawn out upward through the slit portion of the branched channel member 23, and is electrically connected to the wiring board 32. In this manner, the piezoelectric actuator substrate 22 of the head body 20 and the outside can be electrically connected.

The wiring board 32 is positioned above the head body 20. The wiring board 32 distributes signals to the plurality of driver ICs 33.

The plurality of driver ICs 33 are positioned on one main surface of the flexible substrate 31. As illustrated in FIG. 3, in the liquid droplet discharge head 8 according to the first embodiment, two driver ICs 33 are provided on one flexible substrate 31. Note that the number of driver ICs 33 provided on one flexible substrate 31 is not limited to two. The driver IC 33 is an example of a drive controller.

The driver IC 33 drives each displacement element in the piezoelectric actuator substrate of the head body 20 based on a driving signal sent from the controller 14 (see FIG. 1). In this way, the driver IC 33 drives the liquid droplet discharge head 8.

The pressing member 34 is, for example, a plate spring having a substantially U shape in a cross-sectional view. The pressing member 34 is positioned between the two flexible substrates 31, and presses the driver ICs 33 on the flexible substrates 31 toward the heat dissipation plates 45. In this way, the driver ICs 33 are brought into close contact with the heat dissipation plates 45, and thus heat generated when the driver ICs 33 are driven can be efficiently dissipated to the heat dissipation plates 45. The pressing member 34 is an example of a first member having a flat plate shape and positioned between the reservoir 24 and the head cover 40. The pressing member 34 will be described in detail below. Note that the pressing member 34 may bring the driver ICs 33 into contact with the heat dissipation plates 45.

The head cover 40 is mounted on the head body 20, and is disposed covering the wiring portion 30 positioned on the head body 20, such as the flexible substrates 31, the wiring board 32, and the like. In this way, the head cover 40 can seal the wiring portion 30. The head cover 40 is made of, for example, a resin or a metal.

The head cover 40 has a box shape extending long in the main scanning direction and includes a first opening 40a and a second opening 40b at two side surfaces facing each other along the sub-scanning direction, respectively. In the example of FIG. 3, the first opening 40a is provided at the side surface positioned on the positive X-axis direction side, and the second opening 40b is provided at the side surface positioned on the negative X-axis direction side. The head cover 40 also includes a third opening 40c at the lower surface thereof, and a fourth opening 40d at the upper surface thereof.

Two first protruding portions 42 for mounting an auxiliary member 70 described below are provided on the side surface of the head cover 40. A second protruding portion 43 for positioning the pressing member 34 is provided at a lower portion of the side surface having the first protruding portions 42.

The two heat dissipation plates 45 are mounted on the side surfaces of the head cover 40. One of the two heat dissipation plates 45 is disposed closing the first opening 40a, and the other of the two heat dissipation plates 45 is disposed closing the second opening 40b.

The heat dissipation plate 45 is a plate-shaped member that is long in the longitudinal direction of the liquid droplet discharge head 8, and is composed of a metal, an alloy, or the like with high heat dissipation properties, for example. The coefficient of thermal conductivity of the heat dissipation plate 45, for example, the heat dissipation plate 45 is provided in contact with the driver ICs 33 and dissipates the heat generated by the driver ICs 33.

Each of the two heat dissipation plates 45 includes a plurality of through holes 46 into which screws (not illustrated) are inserted. The head cover 40 also includes a plurality of through holes 41 into which the screws are inserted. The plurality of through holes 41 of the head cover 40 are provided at positions corresponding to the plurality of through holes 46 of the heat dissipation plates 45. The screw is inserted into the through hole 41 of the head cover 40 and the through hole 46 of the heat dissipation plate 45 and is fitted into the through hole 41 of the head cover 40. In this way, the two heat dissipation plates 45 are fixed to the head cover 40. The head cover 40 on which the heat dissipation plates 45 are mounted has a box shape in which the first opening 40a and the second opening 40b are closed and the third opening 40c and the fourth opening 40d are open.

The third opening 40c is positioned to face the reservoir 24. The flexible substrates 31 are inserted into the third opening 40c.

The fourth opening 40d is provided for inserting a connector (not illustrated) provided at the wiring board 32. When a space between the connector and the fourth opening 40d is sealed with a resin or the like, liquid, dust, or the like is less likely to enter the head cover 40.

The heat dissipation plate 45 has through holes 48a to 48c at the center portion and both end portions in the longitudinal direction of the head body 20. The heat dissipation plate 45 and the thermal insulating member 50 are fitted to each other by fitting protruding portions 54 of the thermal insulating member 50 described later into the through holes 48a to 48c.

The thermal insulating member 50 is positioned between the heat dissipation plate 45 and the head body 20. A width of the thermal insulating member 50 in the longitudinal direction thereof is greater than a width of the heat dissipation plate 45 in the longitudinal direction thereof. The thermal insulating member 50 is composed of, for example, a resin. The thermal conductivity of the thermal insulating member 50 may be lower than the thermal conductivity of the heat dissipation plate 45. By providing the thermal insulating members 50, heat generated by the driver ICs 33 is less likely to be transferred to the head body 20 via the heat dissipation plates 45.

The thermal insulating member 50 has a plurality of through holes 55 for accommodating screws (not illustrated). Such through holes 55 are positioned at positions corresponding to through holes 245 of the reservoir 24. The screws are fitted into the through holes 55 of the thermal insulating member 50 and the through holes 245 of the reservoir 24, so that the thermal insulating member 50 is fixed to the reservoir 24.

Note that FIG. 3 illustrates an example of the configuration of the liquid droplet discharge head 8, and the liquid droplet discharge head 8 may further include a member other than the members illustrated in FIG. 3.

As described above, in the liquid droplet discharge head 8 according to the first embodiment, the tube 60 and the reservoir 24 are connected by fitting the tube 60 into the boss portion 247 made of resin, and the liquid is supplied from the tube 60 to the reservoir 24. Here, the boss portion 247 made of resin has a lower strength against bending than the boss portion made of metal, which is conventionally used, and thus is likely to be broken when a force is applied in a direction in which the boss portion 247 is bent.

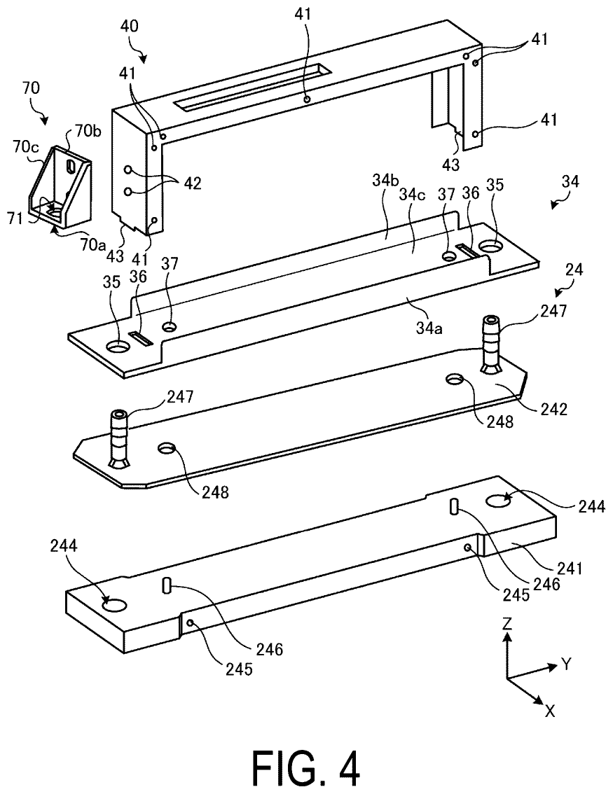

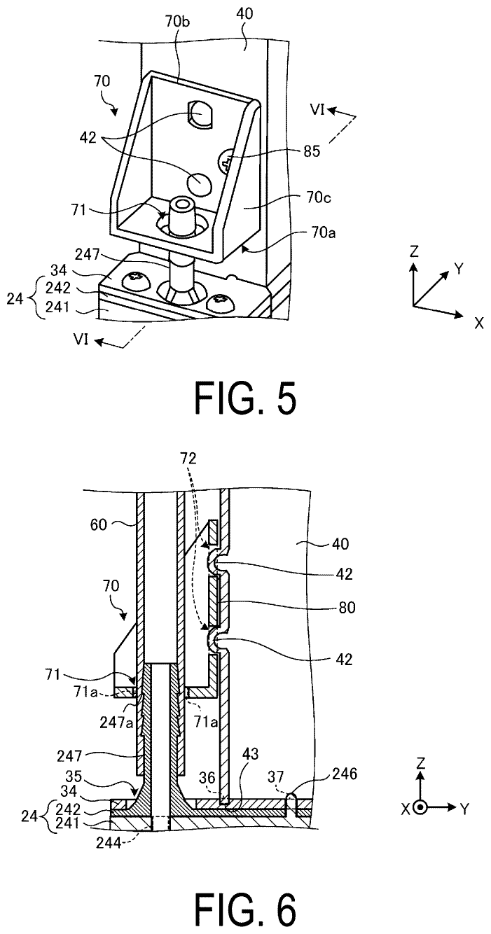

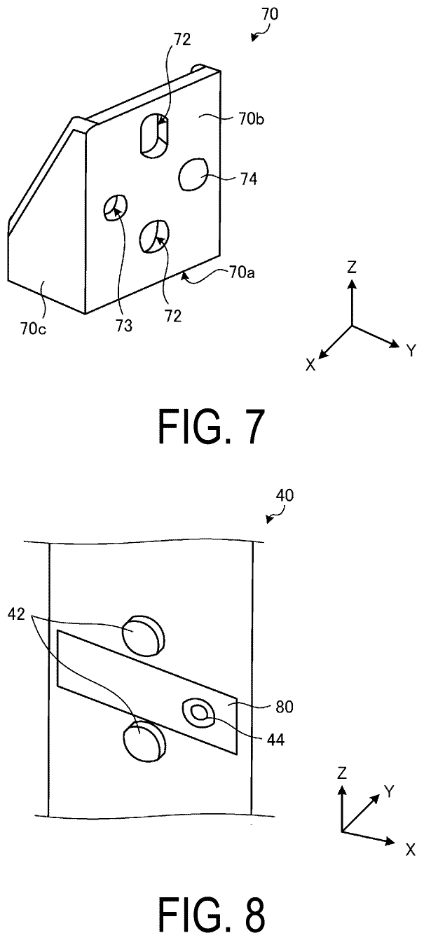

The liquid droplet discharge head 8 according to the first embodiment further includes an auxiliary member 70 that reinforces the boss portion 247. Hereinafter, the auxiliary member 70 and its peripheral members will be described with reference to FIGS. 4 to 8. FIG. 4 is an exploded perspective view illustrating a configuration of the auxiliary member 70 and a peripheral member thereof according to the first embodiment. FIG. 5 is a perspective view illustrating a configuration of the auxiliary member 70 and a peripheral member thereof according to the first embodiment. FIG. 6 is a cross-sectional view taken along the line VI-VI illustrated in FIG. 5. FIG. 7 is a diagram illustrating the configuration of the auxiliary member 70 according to the first embodiment. FIG. 8 is an enlarged view illustrating a configuration of the head cover 40 according to the first embodiment. Note that, in FIGS. 4 and 5, the tube 60 is omitted for ease of understanding.

The auxiliary member 70 is, for example, an injection molded product made of resin. The auxiliary member 70 has a bottom portion 70a, a mounting portion 70b, and sidewall portions 70c connecting the bottom portion 70a and the mounting portion 70b. The bottom portion 70a faces the reservoir 24 and includes a first through hole 71. As illustrated in FIGS. 5 and 6, the first through hole 71 is positioned radially outward of the boss portion 247 and surrounds the boss portion 247 and the tube 60 fitted into the boss portion 247 with a gap 71a. A diameter of the first through hole 71 is, for example, equal to or less than a diameter +0.4 mm of the tube 60 fitted into the boss portion 247.

According to such a configuration, even when a force is applied in a direction in which the boss portion 247 is bent, the force can be received by the auxiliary member 70, and thus the breakage of the boss portion 247 can be reduced. Note that the direction in which the boss portion 247 is bent is a direction intersecting the axis of the boss portion 247. For example, when the direction along the axis of the boss portion 247 is the longitudinal direction of the boss portion 247, the direction in which the boss portion 247 is bent may be a lateral direction or a direction including a component of the lateral direction.

The mounting portion 70b faces the head cover 40 and has a mounting surface on the head cover 40. As illustrated in FIG. 7, the mounting portion 70b includes two through holes 72 into which the first protruding portions 42 of the head cover 40 are fitted, a through hole 73 that accommodate a screw 85 (see FIG. 5), and a recessed portion 74 positioned on a mounting surface on the head cover 40. The recessed portion 74 is, for example, a gate mark.

The through hole 72 is positioned at a position corresponding to the first protruding portion 42 positioned on the side surface of the head cover 40. As illustrated in FIG. 5, the auxiliary member 70 is positioned by fitting the first protruding portion 42 of the head cover 40 into the through hole 72.

The through hole 73 is positioned at a position corresponding to the through hole 44 of the head cover 40. As illustrated in FIG. 5, the auxiliary member 70 is fixed to the head cover 40 by fitting the screw 85 into the through hole 73 of the auxiliary member 70 and the through hole 44 of the head cover 40.

A waterproof material 80 may be positioned between the mounting portion 70b of the auxiliary member 70 and the head cover 40. Specifically, as illustrated in FIG. 7, the waterproof material 80 is disposed closing the periphery of the through hole 73 of the auxiliary member 70 and the through hole 44 of the head cover 40. The waterproof material 80 may also be disposed covering the recessed portion 74 of the auxiliary member 70. When molding the auxiliary member 70, a portion facing a mold is crystallized due to the influence of the temperature of the mold, and thus the strength increases. On the other hand, a portion (gate portion) not facing the mold is less likely to be crystallized and has a relatively low strength, and thus a resistance to ink is relatively low. Therefore, the recessed portion 74, which is a gate mark, can be protected by covering the recessed portion 74 with the waterproof material 80. The waterproof material 80 may be, for example, a double-sided waterproof tape.

The sidewall portion 70c connects the bottom portion 70a and the mounting portion 70b. The sidewall portion 70c has a substantially triangular shape. The auxiliary member 70 includes the sidewall portions 70c, and thus the strength of the liquid droplet discharge head 8 can be enhanced.

Hereinafter, the peripheral members of the auxiliary member 70 will be described with reference to FIGS. 4 to 6. As illustrated in FIG. 4, the reservoir 24 includes a reservoir body 241 and an upper lid 242 positioned on the reservoir body 241. The reservoir body 241 and the upper lid 242 are composed of resin. The reservoir body 241 includes openings 244, and protruding portions 246 for positioning. The openings 244 and the protruding portions 246 are positioned at both end portions of the reservoir body 241 in the longitudinal direction. Specifically, the protruding portions 246 are positioned on an inner side of the reservoir body 241 in the longitudinal direction from the openings 244. The opening 244 is provided at a position corresponding to the boss portion 247 (see FIG. 6).

The upper lid 242 includes the boss portions 247 described above and third through holes 248. The boss portions 247 and the third through holes 248 are positioned at both end portions of the upper lid 242 in the longitudinal direction. Specifically, the third through holes 248 are positioned on an inner side of the upper lid 242 in the longitudinal direction from the boss portions 247.

As illustrated in FIG. 6, the boss portion 247 has a hollow shape and is positioned at a position corresponding to the opening 244 of the reservoir body 241.

As illustrated in FIG. 6, in a middle portion of the boss portion 247, a large-diameter portion 247a having a larger diameter than other portions of the middle portion may be positioned. Here, the middle portion of the boss portion 247 is a region excluding a base portion of the boss portion 247. For example, when the boss portion 247 is divided into three equal parts in the longitudinal direction, a region closest to the upper lid 242 is the base portion of the boss portion 247, and the other two regions are the middle portion. The large-diameter portion 247a functions as a “barb” that reduces the likelihood of the tube 60 coming off. The first through hole 71 of the auxiliary member 70 faces the large-diameter portion 247a as illustrated in FIG. 6. Specifically, the first through hole 71 faces the large-diameter portion 247a positioned at the top among the three large-diameter portions 247a of the boss portion 247.

Since the auxiliary member 70 has the first through hole 71, even when a force is applied in a direction in which the boss portion 247 is bent, the force can be received by the auxiliary member 70, and thus the breakage of the boss portion 247 can be reduced. As described above, when the first through hole 71 is positioned at a position facing the large-diameter portion 247a, the large-diameter portion 247a first comes into contact with the auxiliary member 70 and receives a force, and thus stress is less likely to be applied to the base portion of the boss portion 247.

The third through holes 248 are positioned at positions corresponding to the protruding portions 246 of the reservoir body 241.

As illustrated in FIG. 4, the pressing member 34 includes second through holes 35, groove portions 36 for positioning, and third through holes 37. The second through hole 35s, the groove portions 36, and the third through holes 37 are positioned at both end portions of the pressing member 34 in the longitudinal direction. Specifically, as illustrated in FIG. 4, the groove portions 36 are positioned on an inner side of the pressing member 34 in the longitudinal direction from the second through holes 35. The third through holes 37 are positioned on an inner side of the pressing member 34 in the longitudinal direction from the groove portions 36. The second through holes 35 are positioned at positions corresponding to the boss portions 247. As illustrated in FIG. 6, the boss portions 247 are inserted into the second through holes 35.

The groove portions 36 are positioned at positions corresponding to the second protruding portions 43 of the head cover 40. As illustrated in FIG. 6, the head cover 40 is positioned by fitting the second protruding portions 43 of the head cover 40 into the groove portions 36. In this way, the variation in bending accuracy of the head cover 40 can be reduced. Note that the groove portions 36 may penetrate through the pressing member 34.

The third through holes 37 are positioned at positions corresponding to the protruding portions 246 of the reservoir body 241. The upper lid 242 and the pressing member 34 are positioned by inserting the protruding portions 246 of the reservoir body 241 into the third through holes 248 of the upper lid 242 and the third through holes 37 of the pressing member 34 described above.

As described above, the auxiliary member 70 of the liquid droplet discharge head 8 according to the first embodiment includes the first through hole 71 positioned radially outward of the boss portion 247 and surrounding the boss portion 247 and the tube 60 fitted into the boss portion 247 with the gap 71a. Therefore, even when a force is applied in a direction in which the boss portion 247 is bent, the force can be received by the auxiliary member 70, and thus the breakage of the boss portion 247 can be reduced.

Note that although the example in which the reservoir 24 has the reservoir body 241 and the upper lid 242 has been described here, the configuration of the reservoir 24 is not limited thereto. For example, the reservoir body 241 and the upper lid 242 may be integrally molded. In this case, the integrally molded reservoir 24 may be composed of resin.

Although the example in which the reservoir 24 has the boss portions 247, that is, the boss portions 247 are molded integrally with the reservoir 24 has been described here, the configuration of the boss portion 247 is not limited thereto. For example, the boss portion 247 may be configured as a member separate from the reservoir 24.

### Second Embodiment

### Shape of Auxiliary Member

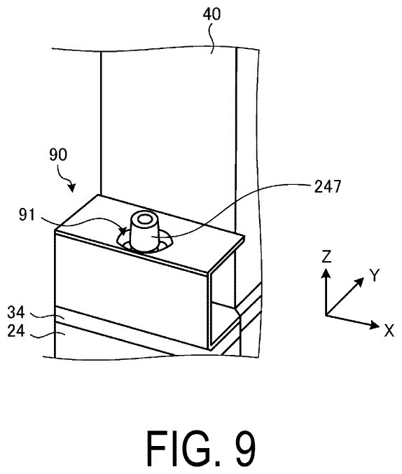

FIG. 9 is a perspective view illustrating a configuration of an auxiliary member 90 according to a second embodiment. The shape of the auxiliary member is not limited to the shape illustrated in FIG. 5. As illustrated in FIG. 9, the auxiliary member 90 may have a U-shape. The auxiliary member 90 is fixed to the pressing member 34 by a screw or the like. Also in this case, the auxiliary member 70 includes a first through hole 91 positioned radially outward of the boss portion 247 and surrounding the boss portion 247 and the tube (not illustrated) fitted into the boss portion 247 with a gap.

In an embodiment, (1) a liquid droplet discharge head (for example, the liquid droplet discharge head 8) includes a channel member (for example, the channel member 21), a reservoir (for example, the reservoir 24), a tube (for example, the tube 60), and an auxiliary member (for example, the auxiliary member 70). The channel member includes a plurality of discharge holes through which a liquid droplet is discharged. The reservoir is positioned above the channel member, supplies a liquid to the channel member, and includes a boss portion (for example, the boss portion 247) made of resin into which the tube is fitted. The tube supplies a liquid into the reservoir. The auxiliary member has a first through hole (for example, the first through hole 71) surrounding the boss portion and the tube fitted into the boss portion with a gap (for example, the gap 71a).

(2) The liquid droplet discharge head according to the above (1) may further include a head cover (for example, the head cover 40) positioned on the reservoir. The auxiliary member may be mounted on the head cover.

(3) The liquid droplet discharge head according to the above (2) may further include a first member (for example, the pressing member 34) having a flat plate shape and positioned between the reservoir and the head cover. The first member may include a second through hole (for example, the second through hole 35) at a position corresponding to the boss portion and a groove portion for positioning (for example, the groove portion 36) on an inner side in the longitudinal direction of the reservoir from the second through hole. The head cover may include a protruding portion (for example, the second protruding portion 43) at a position corresponding to the groove portion.

(4) The liquid droplet discharge head according to the above (3) further includes a drive controller (for example, the driver IC 33) configured to control driving of a head body and a heat dissipation plate (for example, the heat dissipation plate 45) mounted on a side surface of the head cover. The first member presses the driver IC against the heat dissipation plate.

(5) In the liquid droplet discharge head according to the above (4), the reservoir may include a reservoir body (for example, the reservoir body 241) and an upper lid (for example, the upper lid 242) positioned on the reservoir body, the reservoir body may include a protruding portion for positioning (for example, the protruding portion 246), and the upper lid and the pressing member may include respective third through holes (for example, the third through hole 248 and the third through hole 37, respectively) at a position corresponding to the protruding portion.

(6) In the liquid droplet discharge head according to any one of the above (2) to (4), the auxiliary member and the head cover may be fixed by a screw (for example, the screw 85), and a waterproof material (for example, the waterproof material 80) may be positioned between the auxiliary member and the head cover.

(7) In the liquid droplet discharge head according to the above (6), the auxiliary member may be an injection molded product made of resin and may include a recessed portion (for example, the recessed portion 74) positioned on a mounting surface on the head cover, and the waterproof material may cover the recessed portion.

(8) In the liquid droplet discharge head according to the above (7), the waterproof material may be a double-sided waterproof tape.

(9) In the liquid droplet discharge head according to any one of the above (1) to (8), the boss portion may include a large-diameter portion (for example, the large-diameter portion 247a) positioned in the middle portion and having a larger diameter than other portions of the middle portion, and the first through hole may be positioned at a position facing the large-diameter portion.

(10) In the liquid droplet discharge head according to any one of the above (2) to (8), the auxiliary member may include a bottom portion (for example, the bottom portion side 70a) facing the reservoir and including a first through hole, a mounting portion (for example, the mounting portion 70b) facing the head cover and having a mounting surface on the head cover, and a sidewall portion (for example, the sidewall portion 70c) connecting the bottom portion and the mounting portion.

(11) A recording device (for example, the printer 1) may include the liquid droplet discharge head according to any one of the above (1) to (10) and a controller (for example, the controller 14) configured to control the liquid droplet discharge head.

Note that the embodiments disclosed herein are exemplary in all respects and not restrictive. The aforementioned embodiments can be embodied in a variety of forms. The above-described embodiments may be omitted, substituted or modified in various forms without departing from the scope and spirit of the appended claims.

1. A liquid droplet discharge head, comprising:
a channel member comprising a plurality of discharge holes through which a liquid droplet is discharged;
a reservoir positioned above the channel member and configured to supply a liquid to the channel member;
a tube configured to supply the liquid to the reservoir; and
an auxiliary member, wherein
the reservoir comprises a boss portion made of resin into which the tube is fitted, and
the auxiliary member comprises a first through hole surrounding the tube fitted into the boss portion with a gap.

2. The liquid droplet discharge head according to claim 1, further comprising
a head cover positioned above the reservoir, wherein
the auxiliary member is mounted on the head cover.

3. The liquid droplet discharge head according claim 2, further comprising
a first member having a flat plate shape and positioned between the reservoir and the head cover, wherein
the first member comprises a second through hole at a position corresponding to the boss portion and a groove portion for positioning on an inner side in a longitudinal direction of the reservoir from the second through hole, and
the head cover comprises a protruding portion at a position corresponding to the groove portion.

4. The liquid droplet discharge head according to claim 3, further comprising:
a drive controller configured to control driving of the head body 20; and
a heat dissipation plate mounted on a side surface of the head cover, wherein
the first member presses the drive controller against the heat dissipation plate.

5. The liquid droplet discharge head according to claim 4, wherein
the reservoir comprises a reservoir body and an upper lid positioned on the reservoir body,
the reservoir body comprises a protruding portion for positioning, and
the upper lid and the first member comprise respective third through holes at a position corresponding to the protruding portion.

6. The liquid droplet discharge head according to claim 2, wherein
the auxiliary member and the head cover are fixed by a screw, and
a waterproof material is positioned between the auxiliary member and the head cover.

7. The liquid droplet discharge head according to claim 6, wherein
the auxiliary member is an injection molded product made of resin and comprises a recessed portion 74 positioned on a mounting surface on the head cover, and
the waterproof material covers the recessed portion.

8. The liquid droplet discharge head according to claim 6, wherein the waterproof material is a double-sided waterproof tape.

9. The liquid droplet discharge head according to claim 1, wherein
the boss portion comprises a large-diameter portion positioned in the middle portion and having a larger diameter than other portions of the middle portion, and
the first through hole faces the large-diameter portion.

10. The liquid droplet discharge head according to claim 2, wherein
the auxiliary member comprises
a bottom portion facing the reservoir and comprising the first through hole,
a mounting portion facing the head cover and having a mounting surface on the head cover, and
a sidewall portion connecting the bottom portion and the mounting portion.

11. A recording device, comprising:
the liquid droplet discharge head according to claim 1; and
a controller configured to control the liquid droplet discharge head.
